(19) United States
(12) Patent Application Publication
(10) Pub. No.: US 2008/0040723 A1
(43) Pub. Date: Feb. 14, 2008

(54) METHOD AND SYSTEM FOR WRITING AND READING APPLICATION DATA

(75) Inventors: Nils Haustein, Soergenloch (DE); Stefan Neff, Bingen (DE); Ulf Troppens, Mainz (DE); Josef Weingand, Bad Bayersoien (DE); Daniel James Winarski, Tucson, AZ (US); Rainer Wolafka, Bad Soden (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/832,814

(22) Filed: Aug. 2, 2007

(30) Foreign Application Priority Data
Aug. 9, 2006 (DE) 06118643.3

(51) Int. Cl. G06F 9/46

(52) U.S. Cl. 718/104

(57) ABSTRACT

The present invention relates to backup solutions in electronic computing systems and in particular to a method and respective system for managing the storage of application data on a removable storage medium and mounting the removable medium on a according driver device, wherein the application data is cached in a so-called “virtual tape system”, represented by a random-access storage medium, preferably a hard disk, before being written to removable medium or read from removable medium. In order to provide a method including an improved removable medium mount control for increasing the efficiency of removable medium driver device, it is proposed to perform the steps of: managing mount-specific meta data characteristic for removable medium operation workload tasks; predicting upcoming I/O workload based on said meta data; determining based on said calculation, if or when an incoming mount request for mounting a removable medium will be serviced.

### BACKGROUND OF THE INVENTION

1. Field of the Invention

The present invention relates to backup solutions in data processing systems and in particular to a method and respective system for managing the storage of application data on a removable storage medium (e.g., magnetic tape, etc.) and mounting the medium on a respective driver device, wherein the application data is cached preferably in a hard disk, before being written to or read from the removable storage medium. In case of a magnetic tape this cache storage is a so-called “virtual tape system”, represented by a random-access storage medium.

2. Description of Prior Art

Such prior art system is exemplarily described for magnetic tapes in G. T. Kishi, in “The IBM Virtual Tape Server: Making Tape Controllers More Autonomic”, IBM Journal of Research & Development, Vol. 47, No. 4, July 2003. With reference to FIG. 1, each of a plurality of application computers 10A, 10B, 10C hosts a user application 12A, 12B, 12C, respectively, which maintain data that is regularly written on tape and read later from that tape in order to be processed. Tapes 17 A to 17 M are managed in a tape library 19. A cache server 14 has a large hard disk capacity 18 which is controlled by a cache controller 16. This disk cache 18 is used to cache the data before being read from or written to tape 17 in order to provide an efficient access to the data in the storage system.

The term “physical volume” is used to denote an actual tape 17, whereas the term “logical volume” is used to denote a storage area in the disk cache 18. The virtual tape server 14 operates transparently to the user application 12 in a way that the logical volume is emulated thus it appears to the user application like a physical volume.

The term “physical drive” is used to denote an actual tape drive of tape library 19, which is used by the virtual tape server 14 to access a physical volume, whereas the term “logical tape drive” is used to denote virtual tape drive which is emulated by the virtual tape server 14 and appears to the user application 12 like a physical tape drive. The user application 12 uses a virtual tape drive to access data on logical volumes.

The term “physical mount” is used for the process where a physical volume is loaded into a physical drive, whereas the term “logical mount” is used to denote the loading of a logical volume into a logical drive.

Today, there are many methods for virtual tape emulations. Most virtual tape emulator systems provide a disk cache to store virtual tape volumes which are later migrated to physical tape volumes. The migration of physical volumes from disk cache to the back-end physical tape volume and the reverse process, the recall of logical tape volumes from the backend physical tape volume back into the disk cache, requires the physical tape volume to be physically mounted in a physical tape drive to copy logical volumes from the disk cache to the back-end physical tape volume and vice versa. Some virtual tape management systems allow bypassing the disk cache 18, thus applications can direct write to or read from physical tape; for instance when the logical volume to be read is not cached.

With respect to mount processing, virtual tape emulations disadvantageously do not fulfil the following contradicting requirements:

Physical tape drives are a critical cost driving factor for virtual tape systems. Thus, the virtual tape system must avoid the usage of a physical tape drive whenever possible. Policies are required which defer the mount of a physical tape volume until it is proven that it is really required to copy data between the disk cache and the backend physical tape volume, or vice versa.

The access time to logical tape volumes which are migrated to physical tape volumes is a critical factor for the user applications 12A to 12C. Policies are required which mount a physical tape volume as soon as there is an indication that later on a logical tape volume will be accessed which has been migrated to a physical backend physical tape volume.

It is therefore an object of at least one embodiment of the present invention to provide a method including a mount control of a removable storage medium for increasing the efficiency of the utilization of the physical drives.

### SUMMARY OF THE INVENTION

Some virtual tape emulation methods provide audit trails and historic data of recent access to logical volumes done by the applications. This historic data includes statistics on when the cartridge was mounted, by which application the mount request was issued and how long the cartridge comprising a respective tape was mounted. The statistics also include information on how much data was read and written during each tape mount. This information is still not used in prior art, for improving the mount processing, and will be used thus by the inventive method.

Most applications using tapes as data storage schedule tasks which have a predictive workload in advance. For instance, most backup applications write to tape during the night hours to backup data while sometimes this data is read later during daytime for restore purposes. Another, typically scheduled task is the reorganization of the data on tape by copying it from one tape to another, which is also called reclamation or migration.

Various embodiments of this invention teach a system and method for virtual tape systems which keeps track of such scheduled tasks and utilizes this information to improve the prediction.

Thus, according to an embodiment of the invention, a method for managing the storage of application data on a tape storage medium is disclosed, wherein the application data is cached on a random-access storage medium disk before being written to tape or read from tape, wherein the method is characterized by the steps of: managing mount-specific meta data, predicting upcoming I/O workload based on said meta data, determining based on said calculation, if or when an incoming mount request for a logical tape volume will be serviced by mounting a physical tape volume. Preferably, these steps are performed within a single controller program thread.

In another embodiment, mount-specific meta data exemplarily valid for the tape storage media of the present invention comprises at least one of the following: a name of said application, an address of a device issuing a mount command to the virtual tape server, i.e., a library management initiator, an address of a device initiating an input/output (I/O) command to a logical tape drive which is emulated by the virtual tape server, i.e., a host I/O initiator, a time window for scheduling a tape operation workload task, a priority measure associated with said workload task, an identification for a given workload type, a time interval inside which two subsequent mount requests are evaluated to be in some contextual business context, a time datum indicating a last mount of a given physical volume addressing a specific tape, a tape medium type identification label, a tape medium serial number (VOLSER) identification label.

It is further considered that for other storage media types such as magnetic disk, optical tape, optical disk, holographic media, or solid-state memory such as a memory stick, the same or at least similar meta data can be applied, because with respect to mount processing and the business context all these removable media can be managed in the same manner.

By virtue of the present invention, the physical resources in a virtual tape environment such as physical tape drives and libraries are efficiently utilized. The efficiency implemented by means of this invention is that physical tape drive and library resources are only accessed if really needed. This on one hand improves performance for certain tape access requests while utilizing the tape hardware most efficiently.

### BRIEF DESCRIPTION OF THE DRAWINGS

Various embodiments of the present invention are hereinafter described in conjunction with the appended drawings:

FIG. 1 illustrates structural elements of a prior art system environment including a tape library, a virtual tape system and multiple client computers, each implementing a user application the data of which is managed by those systems;

FIG. 2 shows in an environment analogue to FIG. 1 a new disk cache controller implementing a method in accordance with the present invention;

FIG. 3 illustrates a table storing essential control information used in a method in accordance with the present invention;

FIG. 4A, 4B, 4C illustrate the control flow of a method in accordance with the present invention; and

FIG. 5 illustrates a table according to FIG. 3, extended by a further field.

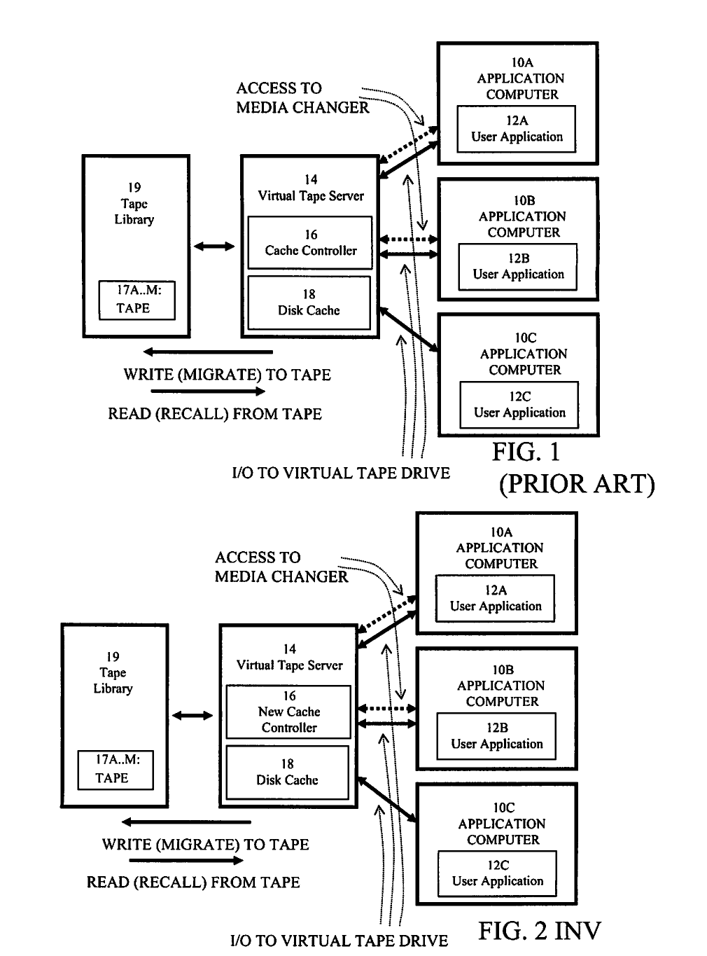

It is to be noted, however, that the appended drawings illustrate only example embodiments of the invention, and are therefore not considered limiting of its scope, for the invention may admit to other equally effective embodiments.

### DETAILED DESCRIPTION

Various embodiments of this invention, described further below, are directed to a system and method for virtual tape systems which keeps track of such scheduled tasks and utilizes this information to improve the prediction.

In the following, the removable storage medium may be assumed to be magnetic tape storage medium. The invention as it is, however, may be applied also for other kinds of removable storage media, because, as a matter of fact, the nature of how the data is actually stored, be that random or sequential access, or be that magnetic, optical, holographic or any other physical way of storing data, is not decisive for the present invention.

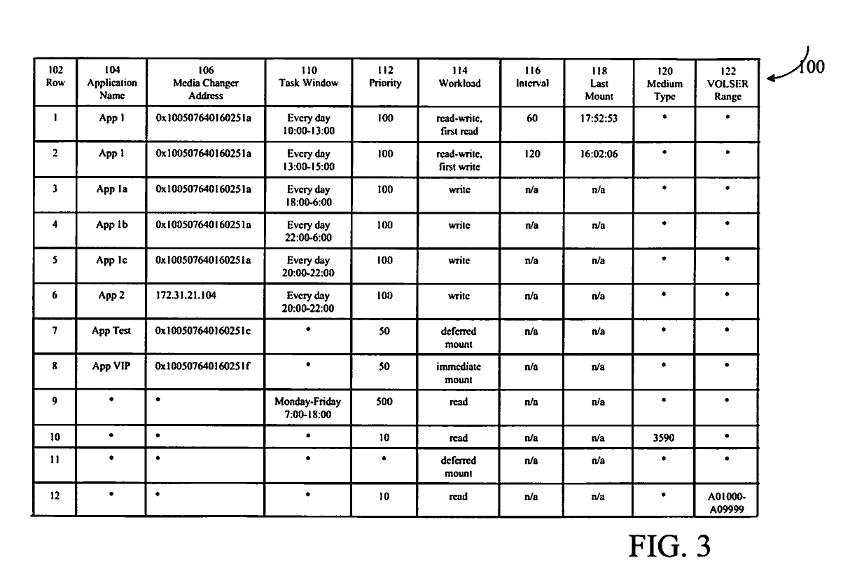

With general reference to the figures and with special reference now to FIG. 2, the preferred embodiment of the present invention is implemented in a disk cache controller device 16 which decides if or if not to serve a mount request from disk or from tape. With further reference to FIG. 3 the system, according to this embodiment of the present invention, stores a table 100 of scheduled tasks which operate on virtual tape volumes. FIG. 3 presents this table 100. Table 100 contains a unique identifier 102 of each row. Each row stores meta data about predictive workload which is used to analyze incoming mount requests to logical volumes. The analysis helps to determine whether the corresponding physical volume should be mounted or not.

Each row in table 100 allows deriving a rule. The rule essentially represents the decision to mount a physical tape volume or not.

The administrator of the virtual tape system can associate each scheduled task with the application name 104 of the application which generates the workload. The example of table 100 in FIG. 3 shows two scheduled tasks for an application App1 with three application clients App 1a, App 1b, and App 1c for LAN-free backup. One task is associated to each of these three clients. Furthermore, the example shows one scheduled task for each application App2, App Test, and App VIP, and four scheduled tasks marked with a ‘*’ which apply for all applications using the virtual tape system.

Today's virtual tape systems provide different interfaces for library management (for example, SCSI Media Changer, IBM 3494). Table 100 records the initiator addresses 106 for library management accesses and the used protocol.

The task time window 110 defines the time frame, when the rule described by this row of table 100 is valid. Various formats are possible. One embodiment uses a crontab-like style to specify valid time frames. The crontab command, found in Unix and Unix-like operating systems, is used to schedule commands to be executed periodically. It reads a series of commands and collects them into a file also known as a “crontab”, which is later read and whose instructions are carried out.

The priority 112 of a rule determines which rule to be selected if multiple rules (rows) are valid for a certain point in time. For instance, in the scenario shown in table 100 of FIG. 3 restore operations are typically executed during the office hours on workdays between 7:00 and 18:00. This is modelled by row 9 of table 100. However, most tape environments compromise other scheduled tasks during the daytime as well. For instance, rows 1 and 2 represent scheduled data reorganizations including read and write access. The priorities of the rules allow a more precise decision in regard to the anticipated mount requests.

The workload type 114 describes the anticipated need for the mount of a physical volume when the application requests to mount a logical volume. Preferably, the following workload types are defined:

read defines a rule where it is anticipated that a mount request to a logical volume is followed by a subsequent read access. For instance, row 9 in Table 100, FIG. 3 models that restore operations are typically scheduled at working days between 7:00 and 18:00.

write defines a rule where it is anticipated that a mount request to a logical volume is followed by a subsequent write access. For instance, row 6 in Table 100, FIG. 3 models that App2 backs-up data to tape every day between 20:00 and 22:00.

read-write (read first) and write-read (write first) define rules where it is anticipated that the application mounts two logical volumes to copy data from one logical volume to another logical volume, for instance, when IBM Tivoli Storage Manager reorganizes the data on tape via space reclamation.

The rule read-write (read first) models the behaviour that the tape using application mounts the input volume first for a read operation and after that the output volume for a write operation.

The rule write-read (write first) models the behaviour that the tape using application mounts the output volume first for a write operation and after that the input volume for a read operation.

Immediate mount defines a rule where the corresponding physical volume should always being mounted when the application mounts a logical volume. For instance, row 8 in Table 100, FIG. 3 models an important application where access time is more important than the consumption of physical tape drives.

Deferred mount defines a rule where the mount of the corresponding physical volume should always being deferred until the first access to data. For instance, row 7 in Table 100, FIG. 3 models a test application where the reduction of physical drive usage is more important than access time.

The interval 116 is only applicable for read-write (read first) and write-read (write first) workload. The interval specifies if a second mount request is considered to be adjacent to a first mount request or not.

The last mount 118 is only applicable for read-write (read first) and write-read (write first) workload and is represented by a time stamp. This time stamp records when the respective rule has been applied the last time. In conjunction with the interval 116 the last mount 118 helps to identify whether a second mount request is considered as a first mount request or as a second mount request. Thereby the second mount request is considered second if it is adjacent to the corresponding first mount request based on the interval field 116.

The medium 120 defines rules for specific cartridge media types. For instance, row 10 of Table 100, FIG. 3 shows an example where a customer migrates from IBM 3590 tape drives to a new tape technology, e.g., IBM 3592 tape drives. Thus IBM 3590 drives media are only used for read operation, but never for write operation.

The tape medium serial number or volume serial (Vol Ser) number may be associated with a range, abbreviated as “volser” range 122. It defines rules for specific tape media serial number ranges. For instance, row 12 of Table 100, FIG. 3 shows an example where a customer has filled WORM (Write Once Read Many) cartridges with barcodes in the range between A01000 and A09999. The logic behind is that write access to filled WORM cartridges is not allowed anymore. Thus further I/O requests must be read requests.

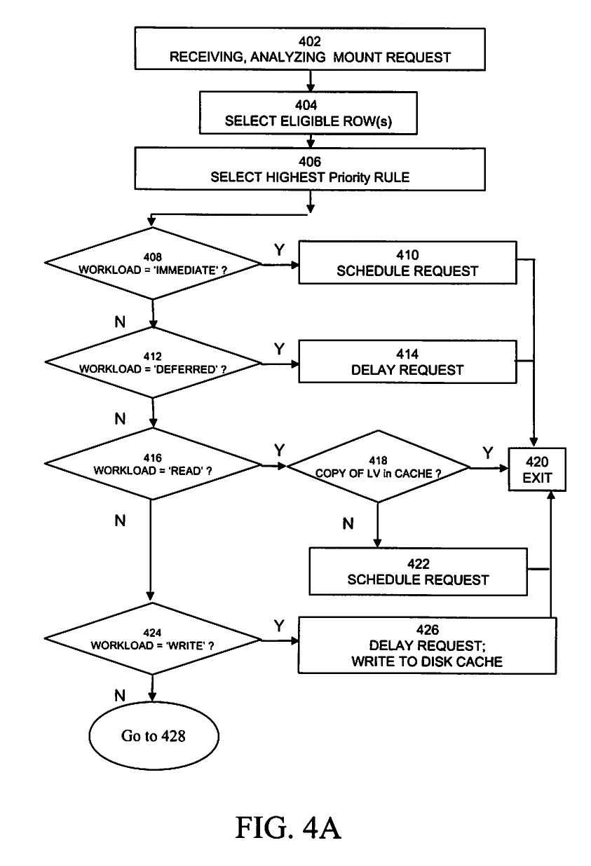

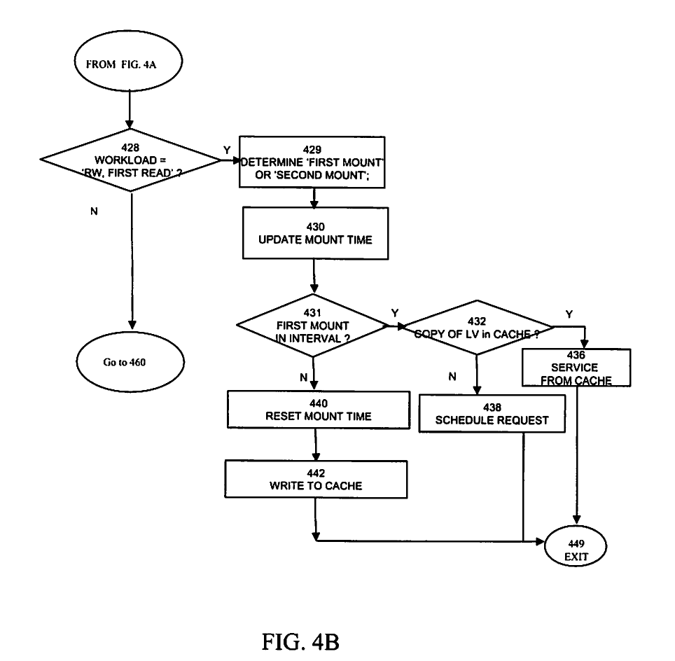

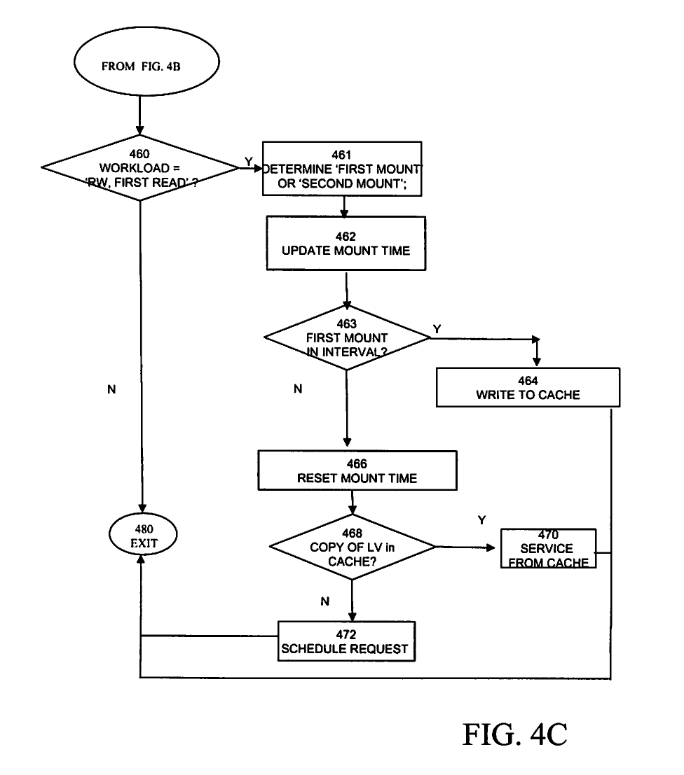

With additional reference now to FIGS. 4A, 4B and 4C, a preferred control flow of a method in a preferred embodiment thereof will be described. It is assumed to be implemented in a controller 16 of the disk cache 18 (FIG. 2) which is assumed to implement control also for tape mount processes. For incoming mount requests issued by an application on a logical tape volume according to this embodiment, the information of Table 100 is used to derive the decision if, and when to load the corresponding physical volume: In step 402 the incoming mount request is received by the controller, and all available control information is extracted and evaluated.

In step 404 the eligible rows of Table 100 are determined such that they match the conditions specified by the values of the columns of the Media Changer Address 106, Task Window 110, medium type 120, and medium volser range 122.

In step 406 the controller logic selects the rule with the highest priority. In case of multiple rows having the same priority 112 one single rule is selected by evaluating further secondary field values. This can be set by the administrator before.

In step 408 the controller logic decides if the workload 114 of the rule which was selected in step 406 indicates ‘immediate’. In the YES case it schedules, step 410, the mount of the respective physical volume immediately and exits this procedure. In the NO case of step 408 the process continues to step 412.

In step 412 the controller logic decides if the workload 114 of the rule which was selected in step 406 indicates ‘deferred’. In the YES case it continues to step 414, and it does not schedule the mount of the respective physical volume and exits this procedure. The logic here is that no physical drive will be occupied until the first I/O to the tape volume is received from the host. This contributes to rest valuable physical resources. In the NO case of step 412 the process flows to step 416.

In step 416 the controller logic decides if the workload 114 of the rule which was selected in step 406 indicates ‘read’. In the YES case it is determined in step 418, if the logical mount request can be satisfied without a physical mount of the corresponding physical volume, for instance, due to the fact that a copy of the logical volume still resides in the disk cache. Then it decides to exit this procedure in step 420, if no mount request is required.

Otherwise, if a mount request is required in the NO branch of decision 418, it decides to immediately schedule a mount request, step 422 and to exit this procedure.

In the NO case of step 416 the process flows to step 424. In step 424 the controller logic decides if the workload 114 of the rule which was selected in step 406 indicates ‘write’. In the YES case step 426 is executed and it does not mount the respective physical volume and exits this procedure in step 420. The data will be written to the disk cache. In the NO case of step 424 the process flows to step 428 of FIG. 4B.

In step 428 of FIG. 4B the controller logic decides if the workload 114 of the rule which was selected in step 406 indicates ‘read-write, first read’. In the YES case the controller logic goes to step 429 and uses the current time, the last mount time (118) and the interval (116) to determine if this is the first mount or the second mount within the mount interval (116). A second mount is present if this mount comes within the mount interval 116 of this rule after the first mount. In the no case of step 428 the process flows to step 460 in FIG. 4C explained later.

In step 430 the control logic updates the last mount time (118) with the current time.

Decision 431 uses the result of step 429 to check if this is the first mount. In the YES case of decision 431 a decision 432 determines if the mount request can be satisfied without a mount of the corresponding physical volume, for instance, due to the fact again, that a copy of the logical volume still resides in the disk cache. If so, the request is serviced from disk cache and it is decided to exit this procedure in step 449. Otherwise, step 438, the request is immediately scheduled as in step 422 above and this procedure exits in step 449.

In the NO case of decision 431 a second mount request within interval (116) has been determined in step 429. The control logic flows to step 440 and updates the last mount time (118) with a time stamp which references to a point in time before the interval; thus the next time, when the rule which was selected in step 406 is evaluated, step 429 determines again a first mount request.

Then the control flow continues with step 442: no physical mount request is scheduled. Instead, a write access is anticipated which will be written to the disk cache. From step 442 it exits this procedure in step 449.

In an alternate embodiment of step 440 the mount time is not reset: Additional meta data is used to determine if this is a third, a fourth, or so mount request to the same rule of table 100 within a certain time interval. In that alternate embodiment of this invention, the administrator can configure the behaviour for the next step 442.

In step 460 of FIG. 4C the controller logic decides if the workload 114 of the rule which was selected in step 406 indicates ‘write-read’, first write. In the YES case the controller logic goes to step 461 and uses the current time, the last mount time (118) and the interval (116) to determine, if this is the first mount or the second mount within the mount interval (116). A second mount is present if this mount comes within the mount interval 116 of this rule after the first mount.

In step 462 the control logic updates the last mount time 118 with the current time.

Decision 463 uses the result of step 461 to check if this is the first mount. In the YES case of decision 463 it does not schedule the mount of the physical volume and exits in step 480. Instead, a write access is anticipated which will be written to the disk cache.

In the NO case of decision 463, a second mount request within interval (116) is determined. The control logic flows to step 466 and updates the last mount time (118) with a time stamp which references to a point in time before the interval; thus the next time, when the rule which was selected in step 406 is evaluated, step 461 determines again a first mount request. From step 466 the process flows to step 468.

In an alternate embodiment of step 466 the mount time is not reset and additional meta data is used to determine if this is a third, a forth, or so mount request to the same rule of table 100 within a certain time interval. In that alternate embodiment of this invention, the administrator can configure the behaviour for the next step 468.

Then the control logic determines in a decision 468, if the mount request can be satisfied without a mount of the corresponding physical volume, for instance, due to the fact again, that a copy of the logical volume still resides in the disk cache. If so, the request is serviced from disk cache, step 470, and it is decided to exit this procedure, step 480. Otherwise the request is immediately scheduled, 472, as in step 422 above. Then it exits this procedure in step 480.

In the NO case of decision 460, further cases could be appended if ever necessary. If no conditions remain to be evaluated, the procedure is exited.

A second preferred embodiment uses the basic structural and control flow elements as does the preceding one, presented in FIGS. 4A, 4B and 4C. But instead, there are some further variations and/or improvements. As described in the preceding embodiment, when an application requests the mount of a logical tape volume the tape emulation system must balance between (a) avoiding to mount physical volumes to reduce the need for expensive tape drives and (b) mounting physical tape volumes as fast as possible to reduce access time to data which is stored on tape but not in the disk cache.

Applications which use tape, for instance backup systems, typically process the following three steps when they access data on a virtual or a physical tape volume:
Mounting of the volume;
Reading of the label which is located at the beginning of the tape media;
Further read from and/or write to the data which is stored on the tape media.
These three basic steps are referred to herein as an “algorithm summary”.

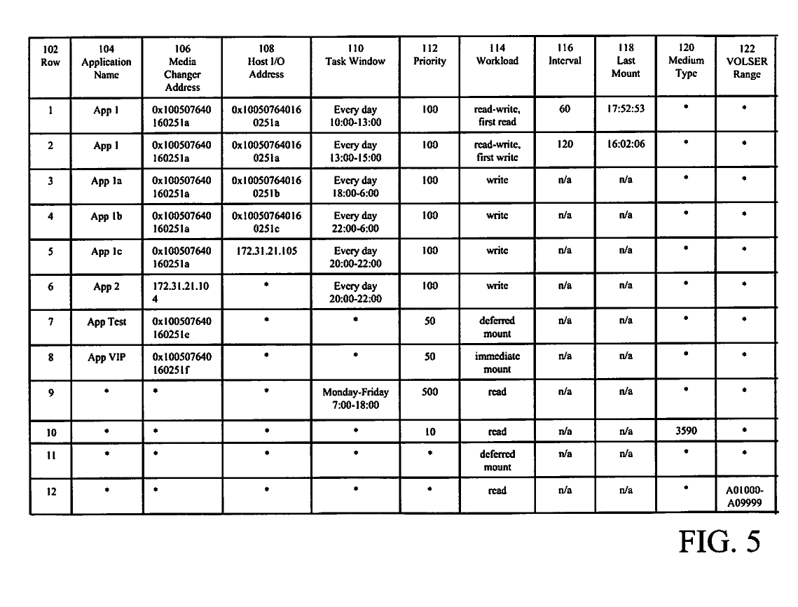

According to the preceding embodiment, the tape emulation system decides during Step 1 of the algorithm summary shortly above whether to mount the respective physical volume or not. But, during Step 2 more information is available; thus upcoming I/O can be predicted more precisely. This is exploited by the second embodiment, which extends the table of FIG. 3 by an additional column, the Host I/O Address 108, which is explained below. The extended table is shown in FIG. 5.

The preceding embodiment predicts upcoming I/O requests only during Step 1 of the procedure above. The second embodiment evaluates the new field of the Host I/O Address 108 which allows recalculating the prediction of upcoming I/O requests during Step 2 of the procedure of the algorithm summary for a second time. Since the recalculation during Step 2 can take into account more information than the calculation during Step 1, the recalculation during Step 2 can predict the upcoming workload even more precisely than the initial calculation during Step 1.

The method according to the second embodiment executes the algorithm which is introduced above in FIGS. 4A, 4B and 4C a second time, when the tape using application verifies the label which is written on tape, which is done during Step 2 of the procedure above. Since the label verification triggers input/output (I/O) from the host application computer 10, Step 2 from the algorithm summary of the procedure introduced in the first embodiment (see step 404 in FIG. 4A) can also make use of the Host I/O Address 108; thus Step 2 of the algorithm summary above is extended when it is executed the second time: Now it uses the control flow of the first embodiment to determine eligible rows which match the conditions Media Changer Address 106, Host I/O Address 108, Task Window 110, medium type 120, and medium volser range 122.

After that the method uses the same steps as introduced in the first embodiment.

As should reveal from the above description an iteration of steps 2) (calculating upcoming I/O workload based on said meta data) and 3) (deciding based on said calculation, if or when an incoming mount request for a logical tape volume will be serviced by mounting a physical tape volume) after having evaluated the address 108 of the device initiating the input/output (I/O) command takes place. The distinction of the library management initiator 106 and the host I/O initiator 108 helps to describe the task windows more precisely. For instance, with the help of the host I/O initiator 108 the tape emulating system can differentiate during the label verification (Step 2 of the summary algorithm described above) whether the logical tape is accessed by a server application 12 or by a Storage Agent which are often implemented for so-called LAN-free backup.

Various options are available to configure the rows in table 100. In one embodiment the rows are updated manually. In one embodiment the tape management system extracts the scheduled tasks from a tape using application and updates table 100 automatically. In one embodiment the tape emulating system analyzes the historic data and statistics of past mount requests: The preferred method is to use the statistic of the last six weeks and to correlate the mount activity of each day of the week (Monday, Tuesday, Wednesday, . . . ) separately, because very often tape using applications comprise daily schedules and weekly schedules. In one embodiment the previously described methods can be mixed.

The present invention can be realized in hardware, software, or a combination of hardware and software. A cache controller of a removable storage medium controller, for example of a virtual tape library system according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

This invention can equally be applied to other storage technologies of removable physical storage media such as holographic storage, optical disk storage, magnetic disk storage, optical tape, or solid-state memory such as a memory stick, in addition to magnetic tape storage.

The present invention can also be embedded in a computer program product, which comprises all the features enabling the implementation of the methods described herein, and which, when loaded in a computer system, is able to carry out these methods.

Computer program means or computer program in the present context mean any expression, in any language, code or notation, of a set of instructions intended to cause a system having an information processing capability to perform a particular function either directly or after either or both of the following
conversion to another language, code or notation;
reproduction in a different material form.

Furthermore, the method described herein may take the form of a computer program product accessible from a computer-usable or computer-readable medium providing program code for use by or in connection with a computer or any instruction execution system. For the purposes of this description, a computer-usable or computer readable medium may be any apparatus that can contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk, read only memory (CD-ROM), compact disk, read/write (CD-RW), and DVD.

What is claimed is:

1. A method wherein application data is stored in a random-access cache before being written to or read from a removable storage medium, and wherein the associated application is executed by a data processing system, the method comprising the steps of:
creating and managing mount-specific meta data from a description of scheduled operations to be performed on the removable storage medium;
predicting upcoming workload for the removable storage medium based on said meta data;
determining based on said prediction, if or when an incoming mount request for mounting said removable storage medium will be serviced.

2. The method according to claim 1, wherein the mount-specific meta data comprises at least one of the following:
a name of said application; an address of a device issuing a mount command; an address of a device initiating an input/output (I/O) command; a time window for scheduling a storage medium operation workload task; a priority measure associated with said workload task; an identification for a given workload type; a time interval inside which two subsequent mount requests are evaluated to be in some contextual business context; a time data indicating a last mount of a given physical volume addressing a specific storage medium; a storage medium type identification label; a storage medium volume range identification label.

3. The method according to claim 2, wherein the predicting and determining steps are performed within a single controller program thread.

4. The method according to claim 3 wherein an iteration of the predicting and determining steps occurs after having evaluated an address of a device initiating the mount request.

5. The method according to claim 4, wherein the removable storage medium is selected from a group consisting of: a magnetic tape, a magnetic disk, a solid-state memory, an optical tape, an optical disk, a holographic media.

6. The method according to claim 5 wherein the random-access storage medium is selected from a group consisting of: a magnetic disk, a solid-state memory.

7. The method according to claim 6 wherein the random-access storage medium is located physically separate from a storage medium for disaster recovery.

8. The method according to claim 6 wherein the random-access storage medium is located in a library device containing the storage medium for disaster recovery.

9. The method according to claim 6 wherein the random-access storage medium is located in a host computer system.

10. A data processing system comprising a removable storage medium controller for managing the storage of application data on a removable storage medium, wherein the application data is cached on a random-access storage medium before being written to or read from the storage medium, the removable storage medium controller comprising means to perform a method comprising:
creating and managing mount-specific meta data from a description of scheduled operations to be performed on the removable storage medium;
predicting upcoming workload for the removable storage medium based on said meta data;
determining based on said prediction, if or when an incoming mount request for mounting said removable storage medium will be serviced.

11. The data processing system according to claim 10, wherein the mount-specific meta data comprises at least one of the following:
a name of said application; an address of a device issuing a mount command; an address of a device initiating an input/output (I/O) command; a time window for scheduling a storage medium operation workload task; a priority measure associated with said workload task; an identification for a given workload type; a time interval inside which two subsequent mount requests are evaluated to be in some contextual business context; a time data indicating a last mount of a given physical volume addressing a specific storage medium; a storage medium type identification label; a storage medium volume range identification label.

12. The data processing system according to claim 11, wherein the random-access storage medium comprises at least one of the following: a magnetic disk, a solid-state memory.

13. The data processing system according to claim 12, wherein the random-access storage medium is located physically separated from the removable media for disaster recovery.

14. The data processing system according to claim 12, where the random-access storage medium is located in a library device containing said storage medium.

15. The data processing system according to claim 12, where the random-access storage medium is located in a host computer system.

16. The data processing system according to claim 12, where the removable storage medium controller is located in a library device containing the storage medium.

17. The data processing system according to claim 16, where the removable storage medium controller is located in a host computer system.

18. A computer program product stored on a computer usable medium comprising computer program code portions for performing a method comprising the steps of:
creating and managing mount-specific meta data from a description of scheduled operations to be performed on the removable storage medium;
predicting upcoming workload for the removable storage medium based on said meta data;
determining based on said prediction, if or when an incoming mount request for mounting said removable storage medium will be serviced, and;
wherein the computer program code portions are executed on a computer.

19. The computer program product according to claim 18, wherein the mount-specific meta data comprises at least one of the following:
a name of said application; an address of a device issuing a mount command; an address of a device initiating an input/output (I/O) command; a time window for scheduling a storage medium operation workload task; a priority measure associated with said workload task; an identification for a given workload type; a time interval inside which two subsequent mount requests are evaluated to be in some contextual business context; a time data indicating a last mount of a given physical volume addressing a specific storage medium; a storage medium type identification label; a storage medium volume range identification label.

20. The computer program product according to claim 19, wherein the predicting and determining steps are performed within a single controller program thread.
